(19) United States
(12) Patent Application Publication
(10) Pub. No.: US 2024/0240999 A1
(43) Pub. Date: Jul. 18, 2024

(54) Measurement apparatus and method for measuring an energy quantity flow transported by means of a liquefied natural gas flow

(71) Applicant: SICK Engineering GmbH, Ottendorf-Okrilla (DE)

(72) Inventors: Sebastian FRIEDRICH, Dresden (DE); Martin OBERLÄNDER, Dresden (DE); Andreas EHRLICH, Dresden (DE)

(21) Appl. No.: 18/411,318

(22) Filed: Jan. 12, 2024

(30) Foreign Application Priority Data
Jan. 13, 2023 (EP) 23151433.2

(51) Int. Cl. G01K 17/16

(52) U.S. Cl. CPC G01K 17/16

(57) ABSTRACT

The invention relates to a measurement apparatus for measuring an energy quantity flow transported by means of a liquefied natural gas flow, comprising an ultrasonic measurement device that is configured to measure the flow velocity of the liquefied natural gas flow and the sound velocity in the liquefied natural gas flow based on determined transit times of ultrasonic signals transmitted and received with and against the flow of the liquefied natural gas flow on a measurement path; a temperature sensor that is configured to measure the temperature of the liquefied natural gas flow; and an evaluation unit that is connected to the ultrasonic measurement device and the temperature sensor to receive respective measurement values for the flow velocity, the sound velocity and the temperature, wherein the evaluation unit is configured to determine the volume flow of the liquefied natural gas flow at least based on the flow velocity and the cross-sectional area of the liquefied natural gas flow, to determine the volume-related calorific value of the liquefied natural gas flow at least based on the sound velocity and the temperature by means of a model function, and to determine the transported energy quantity flow based on the determined volume flow and the determined volume-related calorific value, wherein the model function is determined based on a data set that specifies the volume-related calorific value of a respective composition for a plurality of different compositions of liquefied natural gas. The invention further relates to a measurement apparatus for measuring an energy quantity flow transported by means of a liquefied natural gas flow using a mass flow meter and to corresponding methods.

The present invention relates to measurement apparatus for measuring an energy quantity flow transported by means of a liquefied natural gas flow and to corresponding methods.

Liquefied natural gas is the term for liquefied processed natural gas that is cooled to a temperature below the boiling point, typically to −161° C. to −164° C. Liquefied natural gas is also designated as LNG (abbreviation) and has only about one six-hundredth of the volume of natural gas in its gaseous phase.

Natural gas usually contains a mixture of methane as a main component and further components such as higher alkanes, mainly ethane, propane and butane, as well as nitrogen, carbon dioxide, water vapor and possibly further secondary components. To simplify the storage and transport of natural gas, natural gas extracted from a natural gas production site is transported to a gas liquefaction plant, where it is processed and liquefied by cooling it down. Prior to the liquefaction, certain components are removed from the natural gas, e.g. to prevent a solidification during the liquefaction or to meet customer requirements. Processes such as adsorption, absorption and cryogenic rectification are used for this purpose.

Depending on the geographical origin of the natural gas, in particular depending on the specific production site, and also depending on the respective processing, liquefied natural gas can have different qualitative and quantitative compositions, i.e. both the types of components contained in the liquefied natural gas and their quantity proportions can vary. For example, the mole fraction of methane can vary between 87 mol % and more than 99 mol %.

The transport of liquefied natural gas can take place in a variety of ways, for example by means of pipelines, special ships, tank wagons, tank trucks or tank containers. For billing purposes, it is necessary to detect the quantity of the transported or transferred liquefied natural gas. A quantity measurement of a liquefied natural gas flow transported in a pipeline can, for example, take place by means of suitable flow meters, wherein various methods are used here. A volume flow can, for example, be determined by means of ultrasound-based flow meters. Other flow meters, which are in particular based on the Coriolis principle, enable the determination of a mass flow.

In practice, however, it is not so much the delivered mass or the delivered volume that is relevant for the billing of delivered liquefied natural gas quantities, but the delivered energy quantity. If the calorific value of a detected liquefied natural gas flow is known, it is easily possible to calculate the energy quantity flow based on a measured volume flow or mass flow. Often, however, the specific composition of a liquefied natural gas flow to be detected is not known. To enable a precise conversion of a detected mass flow or volume flow into an energy quantity flow, it is necessary in conventional measurement methods to analyze a sample quantity of the detected liquefied natural gas flow in order to determine the calorific value of the gas sample directly, i.e. experimentally by caloric methods, or indirectly based on a gas chromatographic analysis of the substance composition of the gas sample (for which purpose a regasification of a sample taken from the liquefied natural gas flow is necessary) and a database for the individual calorific values. Such a calorific value determination is, however, associated with a high effort and corresponding costs. Due to the lack of suitable in-situ measurement methods, the determination of the energy quantity flow is furthermore only possible with a time delay.

In US 2019/0219556 A1, a method for measuring the energy content of gas is described in which, beside an ultrasonic sensor, a radar sensor is additionally used to determine the relative permittivity of the gas.

It is the object of the invention to provide a measurement apparatus and a method for measuring an energy quantity flow that is transported by means of a liquefied natural gas flow and that enables a precise measurement even if the qualitative and quantitative chemical composition of the liquefied natural gas flow is only partially known.

The object is satisfied by measurement apparatus having the features of the independent apparatus claims and by methods having the features of the independent method claims.

A measurement apparatus according to the invention for measuring an energy quantity flow transported by means of a liquefied natural gas flow comprises an ultrasonic measurement device that is configured to measure the flow velocity of the liquefied natural gas flow and the sound velocity in the liquefied natural gas flow based on determined transit times of ultrasonic signals transmitted and received with and against the flow of the liquefied natural gas flow on a measurement path; a temperature sensor that is configured to measure the temperature of the liquefied natural gas flow; and an evaluation unit that is connected to the ultrasonic measurement device and the temperature sensor to receive respective measurement values for the flow velocity, the sound velocity and the temperature, wherein the evaluation unit is configured to determine the volume flow of the liquefied natural gas flow at least based on the flow velocity and the cross-sectional area of the liquefied natural gas flow, to determine the volume-related calorific value of the liquefied natural gas flow at least based on the sound velocity and the temperature by means of a model function, and to determine the transported energy quantity flow based on the determined volume flow and the determined volume-related calorific value, wherein the model function is determined based on a data set that specifies the volume-related calorific value of a respective composition for a plurality of different compositions of liquefied natural gas.

The measurement apparatus can, for example, be arranged in or at a pipeline, wherein the cross-section of the pipeline at the location of the flow velocity measurement generally determines the cross-sectional area of the liquefied natural gas flow. The determined energy quantity flow can then, for example, be displayed by a suitable output unit, for example be stored in a memory for further use, or be forwarded directly to a processing and/or billing unit.

With the measurement apparatus according to the invention, the volume flow, i.e. a volume transported per unit of time, is determined in a manner known per se. The determination of the flow velocity based on determined transit times of ultrasonic signals transmitted and received with and against the flow of the liquefied natural gas flow on a measurement path is based on the fact that the transit time of an ultrasonic signal on a measurement path with a predefined length is longer when propagating against the flow of a fluid than when propagating with the flow of the fluid. Not only the flow velocity, but additionally also the sound velocity of the examined fluid can be determined from the transit time or the transit time difference of the respective ultrasonic signals.

The invention utilizes the fact that the chemical composition of liquefied natural gas is at least partially known. Accordingly, it is known which components are present in relevant quantities in the liquefied natural gas and which lower and upper limits are to be expected for the respective quantity proportions of these components. The components of liquefied natural gas are primarily methane (CH₄), ethane (C₂H₆), propane (C₃H₆) and higher alkanes (C₄₊) as well as nitrogen (N₂). Water vapor (H₂O) and carbon dioxide (CO₂) are at least largely no longer contained in liquefied natural gas.

It has been shown that it is possible to describe the calorific value of the liquefied natural gas flow with sufficient accuracy based on only two input variables if a model function is used for this purpose that is based on a data set that specifies the respective calorific value for a plurality of different compositions of liquefied natural gas, and indeed in particular in dependence on the two input variables mentioned.

Specifically, with the aforementioned measurement apparatus, the volume-related calorific value can be determined by means of a model in dependence on the sound velocity and the temperature of the liquefied natural gas flow. The model function used in this model is thus generated for a data set that specifies the volume-related calorific value for a respective known composition in dependence on at least the sound velocity and the temperature.

The term “at least based on the sound velocity and the temperature” is to be understood such that one or more further input variables, in particular additionally also the pressure of the liquefied natural gas flow, may possibly also be considered. However, the influence of the pressure is small and can therefore be neglected if a slightly increased measurement error is accepted.

With the previously adapted model, the volume-related calorific value can be calculated in the measurement process for any desired measured value pair of the sound velocity and the temperature and, from this, the resulting energy quantity flow, i.e. energy or an energy quantity transported per unit of time, can be calculated by multiplying it by the measured volume flow.

The advantage of the measurement apparatus according to the invention is that precise knowledge of the composition of the liquefied natural gas flow is not required. It is sufficient to determine the calorific value by calculation (or also experimentally) for a number of different compositions. The model or model function then makes it possible, with knowledge of the sound velocity and the temperature, to determine the calorific value even for such a composition of liquefied natural gas that is not part of the data set.

According to a preferred embodiment of the measurement apparatus, the model function is an interpolation polynomial that is determined by interpolation of a plurality of support points included in the data set, with the support points specifying a volume-related calorific value determined by calculation and/or experimentally at least for a respective sound velocity and a respective temperature. The polynomial function is thus adapted to the various support points of the data set by a mathematical fit in order to determine the coefficients of the polynomial function. The sampling points of the support points of the data set are the sound velocity and the temperature, preferably also the pressure. The sampling values of the support points are the respective associated volume-related calorific values. By using the interpolation polynomial as a model function with the sound velocity and the temperature as input variables, the volume-related calorific value can therefore be calculated in the evaluation unit. If the pressure is to be considered, it does not necessarily have to be included in the model function, i.e. it does not have to form a further argument of the model function, but can also be considered in the form of a correction factor.

According to a further preferred embodiment, the interpolation polynomial is determined by the equation

$${H}_{V} = {a}_{00} + {a}_{10} \cdot c + {a}_{01} \cdot T + {a}_{20} \cdot {c}^{2} + {a}_{11} \cdot c \cdot T + {a}_{02} \cdot {T}^{2} ,$$

where H_{V} is the volume-related calorific value of the liquefied natural gas flow, c is the sound velocity of the liquefied natural gas flow, Tis the temperature of the liquefied natural gas flow, and aᵢⱼ are coefficients.

A further measurement apparatus according to the invention for measuring an energy quantity flow transported by means of a liquefied natural gas flow comprises a mass flow meter that is configured to measure the mass flow and the density of the liquefied natural gas flow based on the Coriolis principle; a temperature sensor that is configured to measure the temperature of the liquefied natural gas flow; and an evaluation unit that is connected to the mass flow meter and the temperature sensor to receive respective measurement values for the mass flow, the density and the temperature, wherein the evaluation unit is configured to determine the mass-related calorific value of the liquefied natural gas flow at least based on the density and the temperature by means of a model function, and to determine the transported energy quantity flow based on the determined mass flow and the determined mass-related calorific value, wherein the model function is determined based on a data set that specifies the mass-related calorific value for a respective composition for a plurality of different compositions of liquefied natural gas.

The further measurement apparatus according to the invention can also be arranged in or at a pipeline, for example. The determined energy quantity flow can then, for example, be displayed by a suitable output unit, for example be stored in a memory for further use, or be forwarded directly to a processing and/or billing unit.

This further measurement apparatus according to the invention is based on the same principle according to the invention of determining the calorific value of the liquefied natural gas flow by means of a model function. Unlike the aforementioned measurement apparatus, a mass flow meter operating according to the Coriolis principle, which can additionally also determine the density of the liquefied natural gas flow, is used here instead of the volume flow determination by means of an ultrasonic measurement device. The function of such a Coriolis mass flow meter is, for example, based on setting a curved pipe section, which is flowed through by the mass flow to be measured, into oscillation and analyzing the oscillation behavior using measurement technology. In one embodiment, a pipe bend has two legs that oscillate in phase without throughflow. However, if there is a throughflow in the pipe bend, a phase shift occurs between the two legs due to the Coriolis force and can be evaluated accordingly to determine the mass flow. The frequency at which the pipe bend oscillates is proportional to the mass of the substance located in the pipe so that the density of the substance can also be determined by evaluating the frequency of the pipe bend oscillation.

With the previously adapted model, the evaluation unit can, in the measurement process, determine the mass-related calorific value for any desired measured value pair of the density and the temperature and can calculate the resulting energy quantity flow by multiplying it by the measured mass flow. In this variant of the invention, too, the calorific value of the liquefied natural gas flow can be determined not only solely based on the density and the temperature, but additionally also based on the pressure of the liquefied natural gas flow. However, as the influence of pressure is also small here, it can also be neglected.

According to a preferred embodiment of the further measurement apparatus, the model function is an interpolation polynomial that is determined by interpolation of a plurality of support points included in the data set, with the support points specifying a mass-related calorific value determined by calculation and/or experimentally for a respective density and a respective temperature. The interpolation polynomial is adapted to the support points by a mathematical fit in order to determine its coefficients. The input variables of the model function are thus the density and the temperature of the liquefied natural gas flow, preferably also the pressure. Alternatively, the pressure, however, does not necessarily have to be included in the model function, but can be considered in the form of a correction factor.

According to a further preferred embodiment of the further measurement apparatus, the interpolation polynomial is determined by the equation

$${H}_{M} = {b}_{00} + {b}_{10} \cdot ρ + {b}_{01} \cdot T + {b}_{20} \cdot {ρ}^{2} + {b}_{11} \cdot ρ \cdot T + {b}_{02} \cdot {T}^{2} ,$$

where H_{M} is the mass-related calorific value of the liquefied natural gas flow, p is the density of the liquefied natural gas flow, Tis the temperature of the liquefied natural gas flow, and bᵢⱼ are coefficients.

According to preferred embodiments of the above-mentioned measurement apparatus according to the invention or preferred measurement apparatus, the data set comprises a respective group of a plurality of support points for a plurality of different predetermined compositions of liquefied natural gas. A group of support points for a respective predetermined composition of the liquefied natural gas flow consisting of multiple components can, for example, be based on an analysis of a liquefied gas sample taken from a specific production source that may have been carried out in advance or previously. However, as will be explained in more detail below, it is also possible to generate support points for artificially defined compositions that are sensibly within the qualitative and quantitative limits present for real liquefied natural gas compositions. The support points for a respective group can, for example, be generated by calculating the sound velocity and the associated volume-related calorific value or the density and the associated mass-related calorific value as support points for the respective predetermined composition for different temperatures.

According to a further embodiment of one of the above-mentioned measurement apparatus according to the invention or preferred measurement apparatus, a calculation of the support points takes place using the GERG-2008 algorithm, the standard ISO-6578 (ISO 6578:2017, published October 2017) and/or the standard ISO-6976 (ISO 6976:2016, published August 2016). The aforementioned algorithm or the aforementioned standards include precise instructions on how the respective sound velocity, the respective density and the respective volume-related and/or mass-related calorific value can be calculated for a specific liquefied natural gas composition in dependence on the temperature and possibly also the pressure. The GERG-2008 algorithm is, for example, described in detail in the publication “Kunz, O. and W. Wagner, “The GERG-2008 Wide-Range Equation of State for Natural Gases and Other Mixtures: An Expansion of GERG-2004”, J. Chem. Eng. Data, 57 (11), 2012, pp. 3032-3091”.

The invention further relates to a method for measuring an energy quantity flow transported by means of a liquefied natural gas flow, comprising the steps measuring the flow velocity and the sound velocity of the liquefied natural gas flow based on determined transit times of ultrasonic signals transmitted and received with and against the flow of the liquefied natural gas flow on a measurement path; measuring the temperature of the liquefied natural gas flow; determining the volume flow of the liquefied natural gas flow based on the flow velocity and the cross-sectional area of the liquefied natural gas flow; determining the volume-related calorific value of the liquefied natural gas flow at least based on the sound velocity and the temperature by means of a model function, wherein the model function is determined based on a data set that specifies the volume-related calorific value of a respective composition for a plurality of different compositions of liquefied natural gas; and determining the transported energy quantity flow based on the determined volume flow and the determined volume-related calorific value.

The invention furthermore also relates to a method for measuring an energy quantity flow transported by means of a liquefied natural gas flow, comprising the steps measuring the mass flow and the density of the liquefied natural gas flow based on the Coriolis principle; measuring the temperature of the liquefied natural gas flow; determining the mass-related calorific value of the liquefied natural gas flow at least based on the density and the temperature by means of a model function, wherein the model function is determined based on a data set that specifies the mass-related calorific value of a respective composition for a plurality of different compositions of liquefied natural gas; and determining the transported energy quantity flow based on the determined mass flow and the determined mass-related calorific value.

The embodiments described above with reference to the measurement apparatus, in particular the respective determinations of the model function as an interpolation polynomial and the specific embodiments of the interpolation polynomials, analogously represent preferred embodiments of the methods according to the invention.

A common advantage of the measurement apparatus and methods according to the invention is that only a temperature sensor is also required in addition to the already necessary flow meters. The further input variable required in addition to the temperature for a calorific value determination, i.e. the sound velocity or the density, is provided by the respective flow meter as a “by-product”, so to speak, of the actual measurement variable, i.e. the volume flow or mass flow. The effort and/or expenditure for the sensor system can thereby be kept small.

Further advantages result from the following description of the drawings. Embodiments of the invention are shown in the drawings. The drawings, the description and the claims include numerous features in combination. The skilled person will also expediently consider these features individually and combine them into further sensible combinations. There are shown:

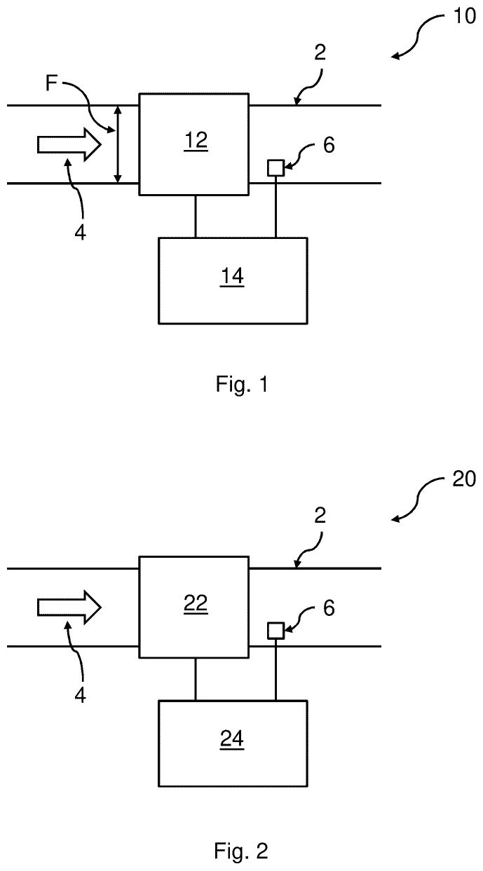

FIG. 1 a block diagram of a measurement apparatus according to a first embodiment;

FIG. 2 a block diagram of a measurement apparatus according to a second embodiment; and

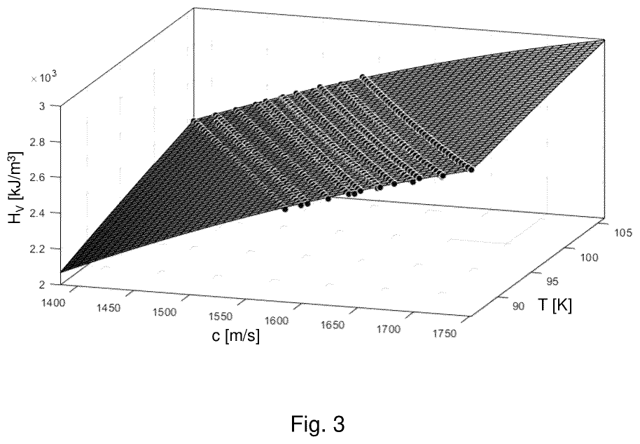

FIG. 3 a three-dimensional diagram of a model function for the measurement apparatus according to FIG. 1.

In the following, the same or similar elements are designated by the same reference numerals.

In FIGS. 1 and 2, exemplary measurement apparatus 10, 20 are schematically shown that are arranged at or in a respective pipeline 2 that is flowed through by a liquefied natural gas 4.

The measurement apparatus 10 according to FIG. 1 comprises an ultrasonic measurement device 12 that is arranged at the pipeline 2 and that is configured to measure the flow velocity of the liquefied natural gas flow 4 and the sound velocity in the liquefied natural gas flow 4 based on determined transit times of ultrasonic signals transmitted and received with and against the flow of the liquefied natural gas flow 4 on a measurement path. The measurement apparatus 10 furthermore comprises a temperature sensor 6 that is arranged at the pipeline 2 and that is configured to measure the temperature of the liquefied natural gas flow 4. Furthermore, the measurement apparatus 10 comprises an evaluation unit 14 that is connected to the ultrasonic measurement device 12 and the temperature sensor 6 to receive respective measurement values for the flow velocity, the sound velocity and the temperature.

The evaluation unit 14 is configured to determine the volume flow of the liquefied natural gas flow 4 based on the flow velocity and the cross-sectional area F of the liquefied natural gas flow 4, said cross-sectional area F, in the embodiment, being determined by the cross-sectional area of the pipeline 2.

The measurement apparatus 20 according to FIG. 2 comprises a mass flow meter 22 that is arranged at the pipeline 2 and that is configured to measure the mass flow and the density of the liquefied natural gas flow 4 based on the Coriolis principle. The measurement apparatus 20 likewise comprises a temperature sensor 6 that is configured to measure the temperature of the liquefied natural gas flow 4. Finally, the measurement apparatus 20 comprises an evaluation unit 24 that is connected to the mass flow meter 22 and the temperature sensor 6 to receive respective measurement values for the mass flow, the density and the temperature.

The mode of operation of the measurement apparatus 10 will now be explained in more detail with reference to FIGS. 1 and 3.

First, some basic principles for determining the energy in a quantity of liquefied natural gas or for determining the energy quantity flow that is transported by means of a liquefied natural gas flow will be explained. The following observations each relate to an energy quantity or energy E, a volume V, and a mass M. It is understood that the relationships can also be analogously applied to the derived quantities of an energy quantity flow, a volume flow and a mass flow since an energy quantity flow is defined as energy or an energy quantity per unit of time, a volume flow is defined as a volume per unit of time, and a mass flow is defined as a mass per unit of time. Accordingly, with the measurement apparatus according to the invention, by integrating a measured transported energy quantity flow over time, energy or an energy quantity transported in this time can in turn be determined. In this regard, the measurement apparatus or methods can also include the function of energy meters.

In general, the energy E released during the combustion of a gas quantity corresponding to a volume V_{LNG} of liquefied natural gas can be described by the equation

$$E = {V}_{LNG} \cdot {ρ}_{LNG} ( T , p , x ) \cdot {H}_{M , LNG} ( x ) . \qquad ( 1 )$$

The energy E is here specified in relation to the combustion under standard conditions, i.e. the combustion of gas at a temperature of 20° C. and a pressure of 0 bar. The volume V_{LNG} of the liquefied natural gas, like its density ρ_{LNG}, refers to the prevailing transport conditions that are determined by the pressure p and the temperature T of the liquefied natural gas. Furthermore, the density ρ_{LNG}, just like the mass-related calorific value H_{M, LNG}, depends on the composition of the examined liquefied natural gas, wherein this dependence on the chemical composition of the liquefied natural gas is illustrated by the argument x. The mass-related calorific value H_{M, LNG} refers to the energy released during the combustion of a certain mass under the above-defined standard conditions (20° C., 0 bar).

In equation (1), possibly occurring energy losses that result during the transmission or due to vaporization of liquefied natural gas are not considered since their detection by measurement technology is associated with considerable difficulties. Any transmission losses can be neglected or, if necessary, considered on a summary or estimation basis.

The energy E released during the combustion of regasified liquefied natural gas results from the equation

$$\frac{E ( {T}_{1} , {p}_{1} , x )}{[ MJ ]} = \frac{V ( {T}_{1} , {p}_{1} )}{[ {m}^{3} ]} \cdot \frac{ρ ( {T}_{1} , {p}_{1} , x )}{[ kg / {m}^{3} ]} \cdot \frac{{H}_{M} ( {T}_{1} , {p}_{1} , x )}{[ MJ / kg ]} , \qquad ( 2 )$$

where T₁ and ρ₁ denote the temperature and the pressure at combustion conditions of the (gaseous) natural gas, e.g. the above-mentioned standard conditions, and T₂ and ρ₂ denote the temperature and the pressure at transport conditions of the (cryogenic) liquefied natural gas.

According to the law of conservation of mass, the following equation results:

$$\frac{V ( {T}_{1} , {p}_{1} )}{[ {m}^{3} ]} \cdot \frac{ρ ( {T}_{1} , {p}_{1} , x )}{[ kg / {m}^{3} ]} = \frac{V ( {T}_{2} , {p}_{2} )}{[ {m}^{3} ]} \cdot \frac{ρ ( {T}_{2} , {p}_{2} , x )}{[ kg / {m}^{3} ]} \qquad ( 3 )$$

Equation (2) can thus be reformulated as:

$$\frac{E ( {T}_{1} , {p}_{1} , x )}{[ MJ ]} = \frac{V ( {T}_{2} , {p}_{2} )}{[ {m}^{3} ]} \cdot \frac{ρ ( {T}_{2} , {p}_{2} , x )}{[ kg / {m}^{3} ]} \cdot \frac{{H}_{M} ( {T}_{1} , {p}_{1} , x )}{[ MJ / kg ]} \qquad ( 4 )$$

The value for V(T₂, ρ₂) is determined in the evaluation unit 14 based on the flow velocity determined by the ultrasonic measurement device 12 under the aforementioned transport conditions and on the cross-sectional area F of the liquefied natural gas flow 4. Thus, to determine the energy E, only the product of the density ρ of the liquefied natural gas at transport conditions (i.e. at T₂, ρ₂) and the mass-related calorific value H_{M} in relation to a combustion under standard conditions has to be determined. This product represents the volume-related calorific value H_{V} of the liquefied natural gas:

$$\frac{{H}_{V} ( {T}_{2} , {p}_{2} , x )}{[ MJ / {m}^{3} ]} = \frac{ρ ( {T}_{2} , {p}_{2} , x )}{[ kg / {m}^{3} ]} \cdot \frac{{H}_{M} ( {T}_{1} , {p}_{1} , x )}{[ MJ / kg ]} \qquad ( 5 )$$

The volume-related calorific value H_{V}(T₂, p₂) thus refers to the volume and the density of the liquefied natural gas under transport conditions, i.e. to the cryogenic liquid phase. Thus, the volume-related calorific value H_{V}(T₂, p₂) reflects the energy per volume of the liquid phase, whereas a volume-related calorific value is usually specified in relation to a combustion in the gaseous phase under standard conditions, i.e. for one energy per volume of the gas phase.

If the composition of the liquefied natural gas flow to be measured were known, the volume-related calorific value could, for example, be taken from a database and included in the calculations of the energy quantity flow. However, this is not possible for unknown or partially unknown liquefied natural gas compositions.

The invention is based on the surprising finding that there is a well-defined relationship between the sound velocity c and the temperature T of the liquefied natural gas, on the one hand, and the volume-related calorific value H_{V} of the liquefied natural gas, on the other hand.

This relationship is shown in FIG. 3. The support points represented by filled circles define associated values for the volume-related calorific value H_{V} of the liquefied natural gas for different values of the temperature T and the sound velocity c. The diagonally extending rows of support points recognizable there each represent a defined chemical composition of the liquefied natural gas.

The support points forming a data set are advantageously determined by calculation from various reference liquefied natural gas compositions by means of established algorithms. For example, the publication “GIIGNL Annual Report 2018”, published by the “International Group of Liquefied Natural Gas Importers”, accessed on Dec. 14, 2022 at: https://giignl.org/document/giignl-2018-annual-report/, includes a data collection for 22 liquefied natural gas compositions originating from different production sites. These data can also be found in the standard ISO-cross-section23306 (ISO 23306:2020, published October 2020). The density, the molar mass and the sound velocity can be determined for various reference compositions by means of the so-called GERG-2008 algorithm, which is described in detail, for example, in the document “Kunz, O. and W. Wagner, “The GERG-2008 Wide-Range Equation of State for Natural Gases and Other Mixtures: An Expansion of GERG-2004”, J. Chem. Eng. Data, 57 (11), 2012, pp. 3032-3091”, and/or the standard ISO-6578 (ISO 6578:2017, published October 2017). The calculation of the mass-related calorific value H_{M} preferably takes place according to the method described in the standard ISO-6976 (ISO 6976:2016, published August 2016).

To determine the support points for a respective composition, a temperature range can, for example, be predefined for which the respective values are calculated. For example, a temperature interval of 10° C., starting from the boiling point of the respective composition, can be selected as the upper limit of the temperature interval that is divided into suitable temperature steps, for example steps of 1° C.

It has been shown that the support points determined by calculation or experimentally can be adapted very well using an interpolation polynomial as a model function:

$${H}_{V} = {a}_{00} + {a}_{10} \cdot c + {a}_{01} \cdot T + {a}_{20} \cdot {c}^{2} + {a}_{11} \cdot c \cdot T + {a}_{02} \cdot {T}^{2} , \qquad ( 6 )$$

where aᵢⱼ are fitting coefficients of this model function.

By using this model function in the evaluation unit 14, the volume-related calorific value H_{V} of the liquefied natural gas flow can be determined at least based on the measured sound velocity c and the measured temperature T of the liquefied natural gas flow. The transported energy volume flow can then be determined based on the determined volume flow and the determined volume-related calorific value H_{V}.

In FIG. 3, the model function according to the interpolation polynomial described in equation (6) is shown as a shaded area.

The measurement method described with reference to the measurement apparatus 10 of FIG. 1 and FIG. 3 can be analogously applied in the measurement apparatus 20 according to FIG. 2 in which a mass flow of the liquefied natural gas is determined by means of the mass flow meter 22. It has been shown that there is also a well-defined relationship between the density p and the temperature T of the liquefied natural gas, on the one hand, and the mass-related calorific value H_{M} of the liquefied natural gas, on the other hand.

With the aid of the measurement apparatus 20, the energy E can be determined analogously to equation (2) based on the mass M of the liquefied natural gas according to the following equation:

$$\frac{E ( {T}_{1} , {p}_{1} , x )}{[ MJ ]} = \frac{M ( {T}_{1} , {p}_{1} , x )}{[ kg ]} \cdot \frac{{H}_{M} ( x )}{[ MJ / kg ]} \qquad ( 7 )$$

Equation (7) can also be written taking into account the law of conservation of mass:

$$\frac{E ( {T}_{1} , {p}_{1} , x )}{[ MJ ]} = \frac{M ( {T}_{2} , {p}_{2} , x )}{[ kg ]} \cdot \frac{{H}_{M} ( x )}{[ MJ / kg ]} \qquad ( 8 )$$

The variables ρ₁, ρ₂, T₁, T₂, x have already been explained above with reference to the measurement apparatus 10 according to FIG. 1.

To calculate the energy or the energy quantity flow based on equation (8), the mass-related calorific value H_{M} is again determined by means of a model function. The density ρ of the liquefied natural gas flow measured by the mass flow meter 22 and its temperature T measured by the temperature sensor 6 are used as input variables for the model function. The following interpolation polynomial is used as a model function for the mass-related calorific value H_{M}:

$${H}_{M} = {b}_{00} + {b}_{10} \cdot ρ + {b}_{01} \cdot T + {b}_{20} \cdot {ρ}^{2} + {b}_{11} \cdot ρ \cdot T + {b}_{02} \cdot {T}^{2} \qquad ( 9 )$$

The fitting coefficients bᵢⱼ can be determined by adapting the interpolation polynomial to a data set that includes support points for various different chemical compositions of liquefied natural gas. The support points of the data set can be calculated using the algorithms already explained in relation to the embodiment of FIG. 1, wherein the GERG-2008 algorithm and/or the standard ISO-6578 can be used for calculating the density and the molar mass and the standard ISO-6976 can be used for calculating the calorific value.

In both variants of the measurement apparatus 10, 20 described or of the corresponding measurement methods, it is not mandatory to generate the data sets for the adaptation of the respective interpolation polynomial on the basis of real chemical liquefied natural gas compositions. Rather, support points for various randomly generated liquefied natural gas compositions can also be generated. Advantageously, these artificially generated compositions are within the limits for minimum and maximum mole fractions that were determined with reference to the 22 real compositions described in the GIIGNL Annual Report 2018 or in the standard ISO-23306. The mole fractions of the various components of these compositions are within the following limits:
Methane: 87.3 to 99.7 mol %
Ethane: 0.09 to 10.3 mol %
Propane: 0.07 to 3.3 mol %
Butane and higher alkanes: 0.01 to 1.5 mol %
Nitrogen (N₂): 0 to 0.7 mol %

The density of these compositions (in the liquid phase) at −160° C. varies between 421 and 467 kg/m³.

The errors occurring when determining the calorific values H_{V}, H_{M} according to the methodology explained above are well below 1%. Error influences in particular result when determining the sound velocity or the density of the reference compositions by calculation based on the GERG-2008 model, when measuring the sound velocity, the density and the temperature, and due to a deviation of the actual pressure under transport conditions from an assumed reference pressure.

The estimation errors for the calorific values H_{V}, H_{M} can be further reduced if the actual pressure of the liquefied natural gas flow 4 is additionally considered, which can, for example, be realized by means of an extended model function or by applying a pressure-dependent correction factor. To measure the pressure of the liquefied natural gas flow 4, a corresponding pressure sensor (not shown) connected to the evaluation unit 14 can be provided in the pipeline 2 in both embodiments.

### REFERENCE NUMERAL LIST

10, 20 measurement apparatus
2 pipeline
4 liquefied natural gas
6 temperature sensor
12 ultrasonic measurement device
14, 24 evaluation unit
22 mass flow meter
F cross-sectional area

1. A measurement apparatus for measuring an energy quantity flow transported by means of a liquefied natural gas flow, comprising
an ultrasonic measurement device that is configured to measure the flow velocity of the liquefied natural gas flow and the sound velocity in the liquefied natural gas flow based on determined transit times of ultrasonic signals transmitted and received with and against the flow of the liquefied natural gas flow on a measurement path;
a temperature sensor that is configured to measure the temperature of the liquefied natural gas flow; and
an evaluation unit that is connected to the ultrasonic measurement device and the temperature sensor to receive respective measurement values for the flow velocity, the sound velocity and the temperature,
wherein the evaluation unit is configured to determine the volume flow of the liquefied natural gas flow at least based on the flow velocity and the cross-sectional area of the liquefied natural gas flow, to determine the volume-related calorific value of the liquefied natural gas flow at least based on the sound velocity and the temperature by means of a model function, and to determine the transported energy quantity flow based on the determined volume flow and the determined volume-related calorific value,
wherein the model function is determined based on a data set that specifies the volume-related calorific value of a respective composition for a plurality of different compositions of liquefied natural gas.

2. The measurement apparatus according to claim 1,
wherein the model function is an interpolation polynomial that is determined by interpolation of a plurality of support points included in the data set, with the support points specifying a volume-related calorific value determined by calculation and/or experimentally at least for a respective sound velocity and a respective temperature.

3. The measurement apparatus according to claim 2,
wherein the interpolation polynomial is determined by the equation
$${H}_{V} = {a}_{00} + {a}_{10} \cdot c + {a}_{01} \cdot T + {a}_{20} \cdot {c}^{2} + {a}_{11} \cdot c \cdot T + {a}_{02} \cdot {T}^{2} ,$$
where H_{V} is the volume-related calorific value of the liquefied natural gas flow, c is the sound velocity of the liquefied natural gas flow, T is the temperature of the liquefied natural gas flow, and aᵢⱼ are coefficients.

4. A measurement apparatus for measuring an energy quantify flow transported by means of a liquefied natural gas flow, comprising
a mass flow meter that is configured to measure the mass flow and the density of the liquefied natural gas flow based on the Coriolis principle;
a temperature sensor that is configured to measure the temperature of the liquefied natural gas flow; and
an evaluation unit that is connected to the mass flow meter and the temperature sensor to receive respective measurement values for the mass flow, the density and the temperature,
wherein the evaluation unit is configured to determine the mass-related calorific value of the liquefied natural gas flow at least based on the density and the temperature by means of a model function, and to determine the transported energy quantity flow based on the determined mass flow and the determined mass-related calorific value, wherein the model function is determined based on a data set that specifies the mass-related calorific value of a respective composition for a plurality of different compositions of liquefied natural gas.

5. The measurement apparatus according to claim 4,
wherein the model function is an interpolation polynomial that is determined by interpolation of a plurality of support points included in the data set, with the support points specifying a mass-related calorific value determined by calculation and/or experimentally for a respective density and a respective temperature.

6. The measurement apparatus according to claim 5,
wherein the interpolation polynomial is determined by the equation
$${H}_{M} = {b}_{00} + {b}_{10} \cdot ρ + {b}_{01} \cdot T + {b}_{20} \cdot {ρ}^{2} + {b}_{11} \cdot ρ \cdot T + {b}_{02} \cdot {T}^{2} ,$$
where H_{M} is the mass-related calorific value of the liquefied natural gas flow, p is the density of the liquefied natural gas flow, Tis the temperature of the liquefied natural gas flow, and bᵢⱼ are coefficients.

7. The measurement apparatus according to claim 2,
wherein the data set comprises a respective group of a plurality of support points for a plurality of different predetermined compositions of liquefied natural gas.

8. The measurement apparatus according to claim 5,
wherein the data set comprises a respective group of a plurality of support points for a plurality of different predetermined compositions of liquefied natural gas.

9. The measurement apparatus according to claim 2,
wherein a calculation of the support points takes place using the GERG-2008 algorithm, the standard ISO-6578 and/or the standard ISO-6976.

10. The measurement apparatus according to claim 5,
wherein a calculation of the support points takes place using the GERG-2008 algorithm, the standard ISO-6578 and/or the standard ISO-6976.

11. The measurement apparatus according to claim 1,
wherein the measurement apparatus further comprises a pressure sensor that is connected to the evaluation unit and that is configured to measure the pressure of the liquefied natural gas flow, with the evaluation unit being configured to receive measurement values for the pressure from the pressure sensor and to additionally determine the calorific value of the liquefied natural gas flow based on the pressure.

12. The measurement apparatus according to claim 4,
wherein the measurement apparatus further comprises a pressure sensor that is connected to the evaluation unit and that is configured to measure the pressure of the liquefied natural gas flow, with the evaluation unit being configured to receive measurement values for the pressure from the pressure sensor and to additionally determine the calorific value of the liquefied natural gas flow based on the pressure.

13. A method for measuring an energy quantify flow transported by means of a liquefied natural gas flow, comprising the steps:
measuring the flow velocity and the sound velocity of the liquefied natural gas flow based on determined transit times of ultrasonic signals transmitted and received with and against the flow of the liquefied natural gas flow on a measurement path;
measuring the temperature of the liquefied natural gas flow;
determining the volume flow of the liquefied natural gas flow based on the flow velocity and the cross-sectional area of the liquefied natural gas flow;
determining the volume-related calorific value of the liquefied natural gas flow at least based on the sound velocity and the temperature by means of a model function, wherein the model function is determined based on a data set that specifies the volume-related calorific value of a respective composition for a plurality of different compositions of liquefied natural gas; and
determining the transported energy quantity flow based on the determined volume flow and the determined volume-related calorific value.

14. A method for measuring an energy quantity flow transported by means of a liquefied natural gas flow, comprising the steps:
measuring the mass flow and the density of the liquefied natural gas flow based on the Coriolis principle;
measuring the temperature of the liquefied natural gas flow;
determining the mass-related calorific value of the liquefied natural gas flow at least based on the density and the temperature by means of a model function, wherein the model function is determined based on a data set that specifies the mass-related calorific value of a respective composition for a plurality of different compositions of liquefied natural gas; and
determining the transported energy quantity flow based on the determined mass flow and the determined mass-related calorific value.
